(19) United States
(12) Patent Application Publication
(10) Pub. No.: US 2006/0254082 A1
(43) Pub. Date: Nov. 16, 2006

(54) Fast clothes dryer and drying method

(76) Inventor: Su Heon Kim, Palatine, IL (US)

Correspondence Address: PYLE & PIONTEK, 221 N. LASALLE STREET,, SUITE 2036, CHICAGO, IL, 60601, US

(21) Appl. No.: 10/535,789

(22) PCT Filed: Nov. 21, 2003
(86) PCT No.: PCT/US03/37490

§ 371 Date: May 22, 2006

Related U.S. Application Data
(60) Provisional application No. 60/428,424, filed on Nov. 22, 2002.
(60) Provisional application No. 60/467,627, filed on May 2, 2003.

(51) Int. Cl. F26B 11/02

(52) U.S. Cl. 34/595

(57) ABSTRACT

A fast clothes dryer (10) is provided and has a blower (32) located after the dryer lint trap (19) to recover air, boost its velocity and then distribute it throughout the dryer, includes the dryer door (12), dryer fins (28) and dryer circumference. If additional drying is desired, the recovered air can be dehumidified before it is distributed throughout the dryer (10). The inclusion of just one of these features, the air flow through the dryer door (12) can cut drying time from say 20 minutes to 15 minutes, with less wrinkling. The dryer and method use cold air to dry clothes without shrinkage, and to avoid tumbling at initial stages of drying. The clothes may be initially dried at a warm temperature and at a speed high enough to prevent mechanical tumbling for a first period (say 20 minutes) using rotation first in one then the other direction. Then, when partially dry, cold dehumidified air is used with a lower drum rotation speed to permit very gentle tumbling with the drum rotation varying In directions for a second period of say 15 minutes. Thereafter, the clothes may be normally dried at a normal temperature and medium drum speed until done, say for another 10 to 15 minutes.

This United States PCT application is a continuation of U.S. provisional patent applications Ser. No. 60/428,424, filed Nov. 22, 2002, entitled FAST CLOTHES DRYER and Ser. No. 60/467,627, filed May 2, 2003, entitled DRYING METHOD AND APPARATUS by the same inventor for which claims of benefit of their respective filing dates and priority are made.

This invention relates to clothes dryers and clothes drying and more particularly to a method and apparatus for fast, energy efficient, clothes dryers and their use to quickly dry clothes and to a drying method and apparatus, particularly for use with drying fine clothing, which heretofore was usually dry cleaned, without shrinking.

### BACKGROUND OF THE INVENTION

Heretofore, it is known to have a clothes dryer utilizing hot air provided by a heat source, such as a gas burner and/or a heat exchanger, such as one utilizing steam (see U.S. Pat. No. 4,665,628 which is incorporated herein by reference). It is also known to construct a dryer using dehumidified air to dry the clothes (see U.S. Pat. Nos. 4,640,022 and 5,361,511 which are incorporated herein by reference). It is also known to discharge recovered exhaust air (see U.S. Pat. No. 3,959,892 which is incorporated herein by reference) around the perimeter of the clothing entrance door of the dryer (see U.S. Pat. Nos. 2,694,867 and 3,121,000 which are incorporated herein by reference). However, dryers of the prior art have not been capable of drying clothes quickly. Consequently, users, such as commercial laundries and dry cleaners who use dryers in their businesses, have either had to slow down their operations to accommodate the dryer's drying speed or purchase additional drying capacity. The present invention can be used with my washer disclosed in the above copending provisional application Ser. No. 60/428,424, filed Nov. 22, 2002, entitled Fast Clothes Dryer and PCT application Serial No. PCT/US03/12156, filed Apr. 18, 2003 to very cold wash clothes heretofore dry cleaned.

### SUMMARY OF THE PRESENT INVENTION

The present invention is a method and apparatus for drying clothes and comprises a dryer housing, having a dryer drum, a means for providing heat to the dryer, a lint trap, a means for recovering some of the heated air after the lint trap, means for distributing the recovered air throughout the dryer, including one or more of the following: distributing recovered air through the door of the dryer, distributing recovered air to one or more positions adjacent the outer circumference of the dryer drum, and distributing recovered air into and from the fins within the dryer drum The recovered air may be supplied by means for moving the air such as a blower, which may be blower means, such as the main blower of the dryer, or preferably by an additional or auxiliary blower. The blower is preferably driven by an electric motor. To enhance drying, the air from the means for air moving, could be first sent to a dehumidifier to remove moisture in the air and then sent to the means for distributing, i.e., a distribution manifold and associated ducting and then throughout the dryer. As to the air supplied to the door, a flexible duct connection or other means such as built in ducting can be provided to accommodate door movement. Where recovered air is supplied to the dryer drum fins, as they move and the supply duct does not, a rotary air joint can be provided in this distribution path to make the connection.

The method of the present invention includes the step of recovering heated air from the dryer after the lint trap, boosting the velocity of the recovered air, distributing the recovered air into various parts of the dryer, including the axial center of the drum, the outer circumference of the drum, and in one or more directions along the periphery of the drum, these areas being, for example, the center of the door, the center-sides of the drum, and into and through the fins on the drum. The method may also include the step of dehumidifying the recovered air before it is sent into various parts of the dryer.

Use of the dryer with the foregoing features is believed to cut dryer time by at least 20 to 50%. Even with just the use of the through-the-door air delivery system, drying time has been reduced from 20 minutes drying time to just 15 minutes drying time (a 25% reduction). Not only is drying time reduced, the energy supplied as heat is also reduced generally in proportion to the reduced drying time. Further, the additional air flow greatly supplements the tumble action of the dryer drum's rotation and results in less wring in the clothes as they come from the dryer. This results in further time and energy savings as less work and time is needed to subsequently press or iron clothes dried in the dryer and method of the present invention.

The invention includes a further embodiment of drying apparatus and a method for operating the same. The apparatus includes the use of recirculating air which may be cooled and/or dehumidified to prevent shrinkage of clothing. In this embodiment, the recirculated air is discharged back into the dryer drum through a large say 2″×4″ rectangular duct situated near the dryer W door's periphery, but on the dryer cabinet, rather than in the door.

In the method, the cloth or clothes go through a simulated “lung drying” or “blocking drying” portion of the cycle. That is, they are dried in a maimer similar to hanging from a line 4 with little or no mechanical action (tumbling), to prevent shrinkage by at least for a period rotating the dryer drum with sufficient speed to hold the clothes pinned against the drum. This dries one side of the clothes. Then the drum is momentarily halted so the clothes fail and reorient themselves and the dryer drum rotation is reversed, again maintaining speed to keep the clothes pinned to the drum. These two steps may be repeated several times say for a duration of 15 to 25 minutes, with say 4 direction reversals and about four 5-minute drying cycles being preferred. Thus, both sides are dried essentially without tumbling. The elimination of tumbling at this initial drying stage will prevent shrinkage heretofore seen due to mechanical tumbling action At this stage, the air may be quite warm say from 100° to 135° with about 120° being preferred. The tolerance in the temperatures may be about plus or minus 5° F. The air used is dehumidified to remove the moisture and then recirculated back into the drum, or could be taken from the environment and exhausted to the environment, but the former is preferred.

For example, with a dryer drum of about 3 feet in the drum speed might be 50 to 90 RPM with about 75 RPM being preferred for this initial “hang drying” phase. To achieve this speed, the dryer drum drive can provide different speeds, such as by “chopping” the electric current to the motor. The above speeds are say plus or minus 10 RPM with this drum diameter. The drum diameter and speed being chosen during the hang “drying” phase to keep the clothes held on the drum and avoid tumbling. Of course, the drum speed and diameter are selected or designed to achieve the desired effect. The motor drive alone is of course capable of variable speed, such as by motor drive selection, or less desirable due to higher costs, the use of a transmission say of the variable speed or other type.

Next in what is called the “gentle” portion of the cycle, the dryer drum is greatly slowed down to a drum speed that very gently tumbles the clothes. During the gentle cycle the drum is rotated one direction at slow speed, say 20 to 15 RPM For a 3 foot diameter drum, with about 17 to 18 RPM being preferred, for a short time, say 15 to 30 seconds, then stopped and the direction of rotation of the drum reversed and again stopped. These “gentle” cycle motions are repeated for say 10 to 20 minutes with about 15 minutes being preferred. Again, these times have tolerances say plus or minus 3 seconds for time measured in seconds and plus or minus 3 minutes for time measured in minutes. In the “gentle” cycle, heated air is not used, and instead cold air is used say on the order of 50° F., again say plus or minus 15° F., with 50° F. being preferred. The use of cold air when the gentle tumbling takes place greatly ran y tending of the clothes to shrinks Again, the air is cooled and dehumidified and recycled back to the dryer drum in the gentle portion of the cycle.

After about 15 minutes of gentle cycle, the clothes are nearly dry and less susceptible to shrinking.

After the gentle portion of the drying cycle, the clothes can be normally dried, say again with about 120° F. air, with optionally the dehumidification of the recycled air being continued for about 15 minutes and/or until dry. During this phase, the drum speed can be increased say to about 35 RPM to provide normal tumbling. Again the speed could be plus or minus 10 RPM.

The advantage of the system of the present invention is that the clothes can be “dry cleaned” in my above described washer method and apparatus and then dried in my above described dryer method and apparatus and herein within about one hour without any shrinkage or worries about customer complaints.

### BRIEF DESCRIPTION OF THE DRAWINGS

FIG. 1 is a schematic front elevation view of a clothes dryer incorporating and for use in practicing the present invention.

FIG. 2 is a schematic view similar to FIG. 1, but with a portion of the front wall broken away to illustrate the motor, blower, dehumidifier and recovered air distribution manifold therein and with portions of the recovered air distribution manifold ducts shown in dashed lines.

FIG. 2A is a schematic view of an alternative arrangement showing the dehumidifier mounted between the blower and portions of the recovered air distribution manifold.

FIG. 3 is a schematic top view of the dryer shown in FIG. 1, with the screen of the dryer drum only partially shown and the blower, motor and recovered air distribution manifold shown in phantom.

FIG. 4 is a schematic top view taken below the top of the dryer housing and illustrates a cross-section of the dryer drum showing how air is provided to and discharged from the dryer, drum fins, blower, dehumidifier, motor, recovered air distribution manifold and ducting.

FIG. 5 is a schematic front elevational view, similar to FIG. 1, but taken behind the front panel of the dryer, to show the drum, blower, motor, optional dehumidifier air distribution manifold and ducting.

FIG. 6 is an enlarged schematic perspective view of the dryer drum showing the dryer screen perimeter and dryer drum air distributing fins.

FIG. 7 is an enlarged schematic axial cross-sectional view of the dryer drum showing how air is supplied to the air distributing fins, via rotary air joint 78 and its associated duct 44.

FIG. 8 is a view similar to FIG. 7 using arrowheads to illustrate drying air flow.

FIG. 9 is a view similar to FIG. 1 using arrowheads to illustrate drying air flow.

FIG. 10 is a view similar to FIG. 3 using arrowheads to illustrate drying air flow.

FIG. 11 is Graph I of water weight vs. drying time showing how the present invention speeds up drying and reduces drying time.

FIG. 12 is Graphic II of water weight vs. drying time.

FIGS. 13 and 14 are a comparison showing how the present invention also reduces wrinkling even with the shorter drying time; FIG. 13 showing a piece of clothing with wrinkles produced in a conventional dryer, and FIG. 14 showing reduced wrinkling when the same dryer of the present invention is used.

FIG. 15 is a block diagram illustrating the air flow path through the dryer of the present invention.

FIG. 16 is a schematic of the drying cycle of temperature v. time.

FIG. 17 is a schematic of the further embodiment of the dryer of the invention.

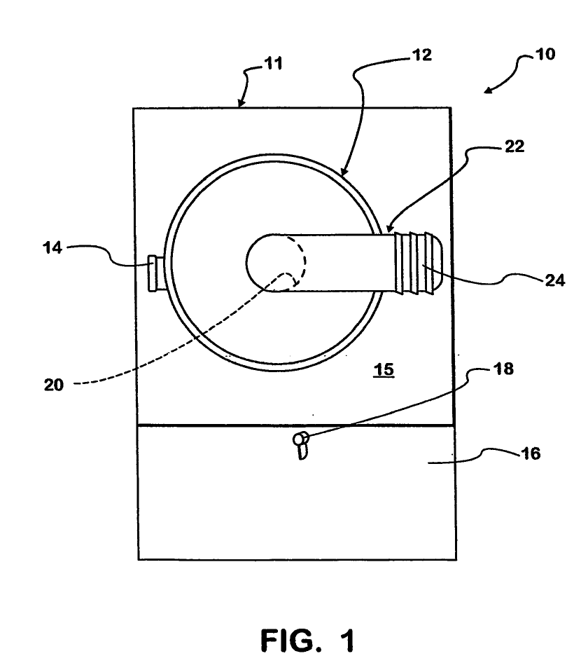

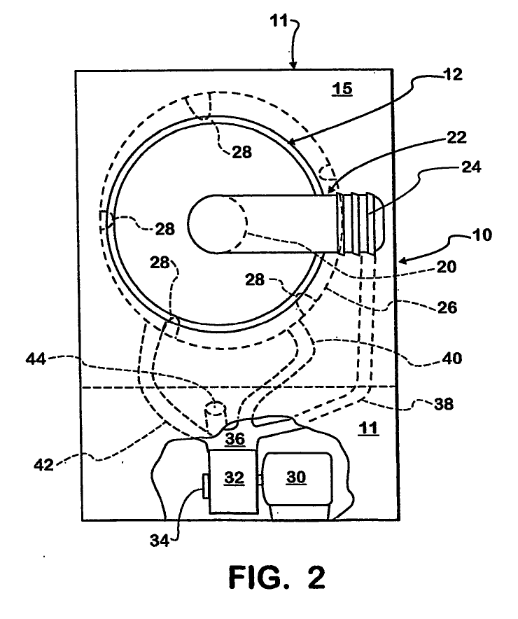

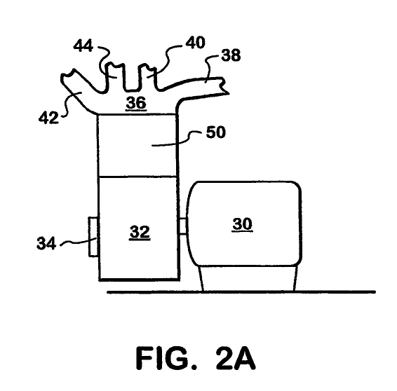

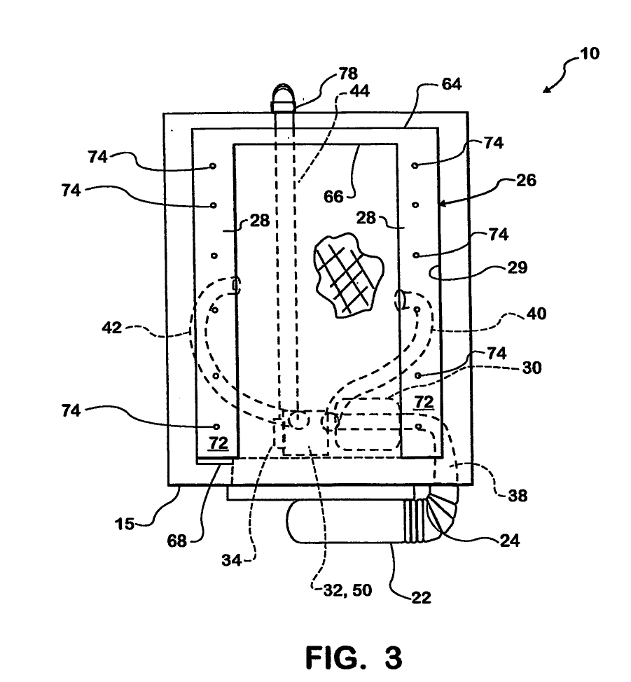

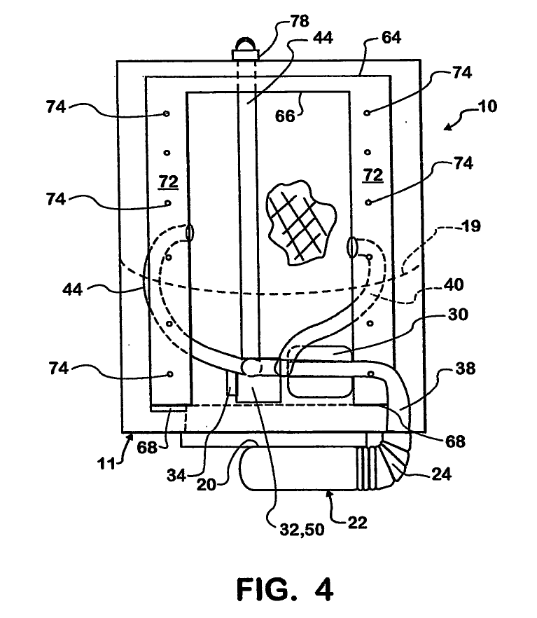

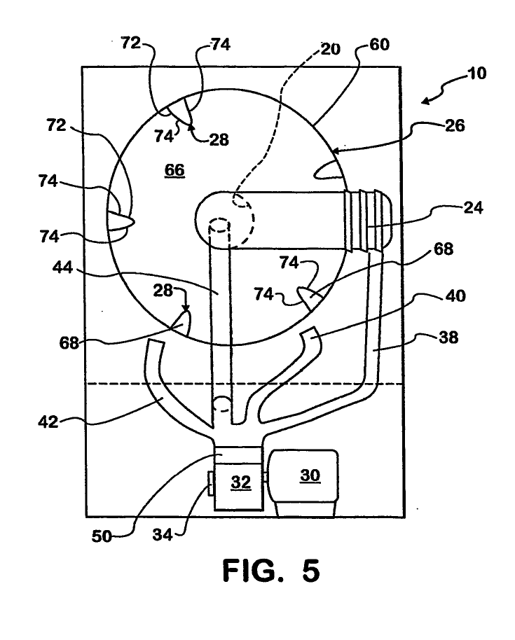

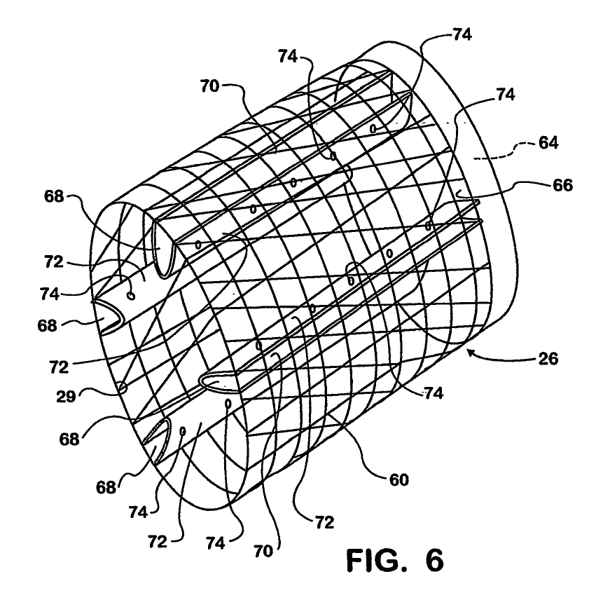

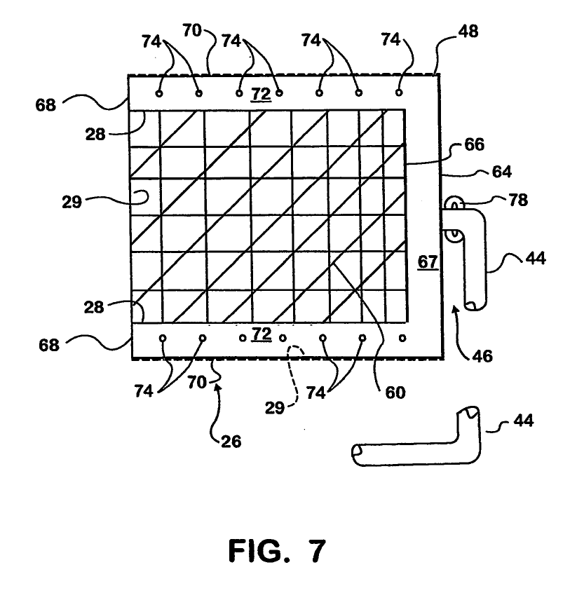

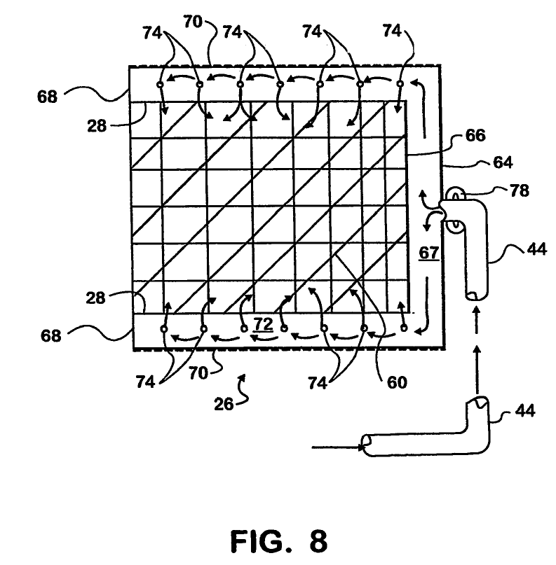

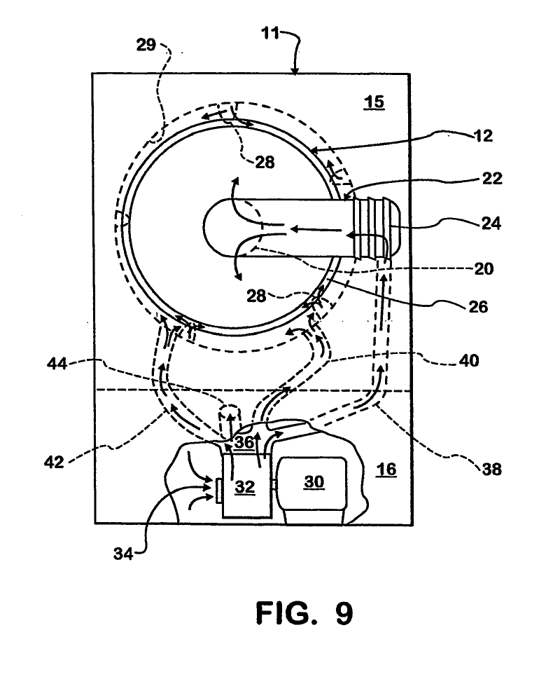

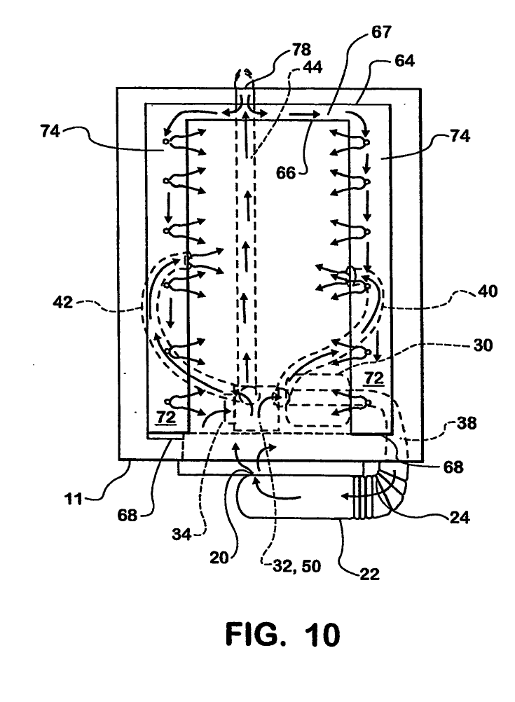

### DESCRIPTION OF THE PREFERRED EMBODIMENTS

Referring now to the drawings in greater detail, there is illustrated therein a dryer made in accordance with the teachings of the present invention and generally identified by the reference numeral 10.

The dryer includes a housing 11 within which a door 12 is provided through which items, for example, clothes, are inserted for drying and removed thereafter. Typically such door includes a handle 14 which may or may not include a lock. The door is also typically mounted in a front door panel 15 of the housing 11.

The dryer 10 also typically includes a lint door 16 having a handle 18 thereon, a lint trap 19 in the form of a cloth or mesh sack or sock of the dryer 10 being situated behind the lint door 16.

In the dryer 10 illustrated, an opening 20 is provided in or adjacent the door 12, within and to which one end 21 of a door air duct 22 is engaged. The door air duct 22 is engaged via a flexible connection 24 such as flexible hose. The flexible duct for the door duct could be of the bellows type and made of rubber or plastic. The duct connection 24 is flexible to allow for opening and closing of the door 12.

Positioned within the housing 11, behind the clothes door 12 is a dryer drum 26 which incorporates radial fins 28 on an inner surface 29 thereof, the cylindrical surface of the drum being formed by a metal open mesh or screen. Thus, as the dryer drum 26 rotates, the fins 28 assist in producing, when desired, tumbling of clothes therein, for the drying of same.

A heater 31 of any suitable type is provided in the dryer 10 for heating air moved through the drum 26 by the main blower, and if provided, a motor 30 of an auxiliary blower 32. Heated recovered air enters the blower 32 through an inlet 34 thereto, a suitable heater being, for example, a gas burner or of the hot water or steam heated heat exchanger.

The motor 30 drives the blower 32 to draw air from the dryer after the air passes through the lint trap. From the blower 32 the air is directed into a distribution manifold 36 which sends air to various areas of the drum 26 via a plurality of ducts, such as, for example, a door duct 38, a right side duct 40, a left side duct 42, a rear duct 44, or any combination suitable for the purpose of drying clothes within the drum 26. Alternatively, it will be understood that the blower 32 could be powered by the dryer main motor, rather than by the auxiliary blower motor 30.

The recovered air duct diameters are for example, two to six inches, with about three inches being preferred. Also, if desired, a dehumidifier 50 may be incorporated into the recovered air path to remove moisture from the recovered air provided to the drum 26.

The blower motor 30 in this embodiment is made by Dayton under model No. 2C946B, and provides airflow at 320 cubic feet per minute. Any blower providing airflow from 200 to 1000 cubic feet per minute could be used. The motor 30 for the blower 32 is rated at ⅙ horsepower. The drum 26 in the preferred embodiment is made of a screen mesh material and includes a double wall 46 on a rear end 48 thereof comprising an outer rear wall 64 and an inner rear wall 66 defining an air chamber 67 therebetween, the air chamber 67 feeding air into, through and out of the fins 28 of the drum 26 as will be described in greater detail below.

The drum fins 28 are generally each triangular in cross section and include a closed forward end 68, together with a closed outer wall 70 which is adjacent the drum 26. A rear end 71 of each fin is open and is connected to and forms a continuation of the air chamber 67 at the rear end 48 of the drum 26. Each fin also comprises two inner walls 72 which converge toward one another as they generally radially extend into the drum 26. Each inner wall 72 incorporates a plurality of air ports or outlets 74 therein, through which air from the chamber 76 is released into the drum 26. The fin openings are of ⅛ to ½ inches with ¼ inches preferred. These air ports can be provided on both sides of each fin and spaced several inches apart.

Inasmuch as the drum 26 is rotating as drying of articles therein proceeds and the air supply feeding the air chamber 67 is stationary, a rotary joint 78 such as that manufactured by SKP is interposed therebetween. The rotary joint is sufficient size to feed air through the dryer drum shaft to the fins. If need be, the dryer drum shaft can be sized to have an air path therethrough to give an acceptable air flow quantity.

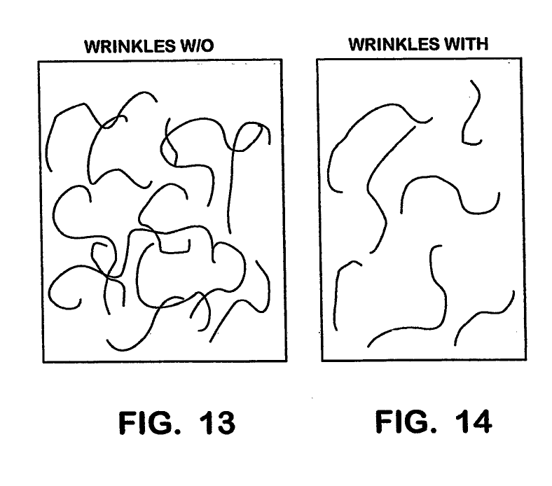

As the articles in the dryer drum 26 come into contact with the fins 28, in known manner, to aid in tumbling of the articles within the dryer 10, air exiting the air ports 74 further assists in drying of articles and in moving the articles out of contact with the fins 28. The added air flow in the dryer not only enhances drying, it wrinkling (see FIGS. 13 and 14).

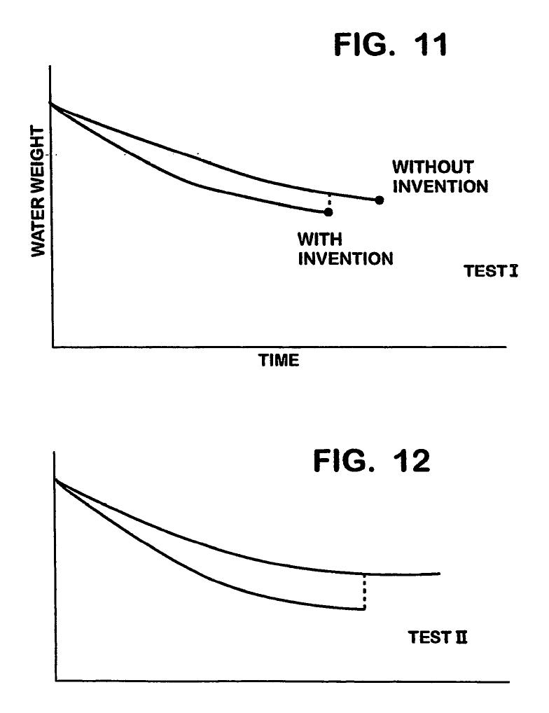

Turning now to FIGS. 11 and 12 there is shown in each graphic illustration of results of empirical testing how the dryer 10 of the present invention (with just door recovered air flow) is of greater effectivity than a conventional dryer (50 lbs. clothes weight, made by Speed Queen), showing that water weight of articles dried in the dryer 10 decreases far more quickly, and consequently the articles dried more quickly as well.

Further, referring to wrinkling of articles being dried, it has been found that wrinkling is significantly decreased by the dryer 10 of the present invention as shown in FIG. 14, as compared to wrinkling produced by a conventional dryer, as shown in FIG. 13.

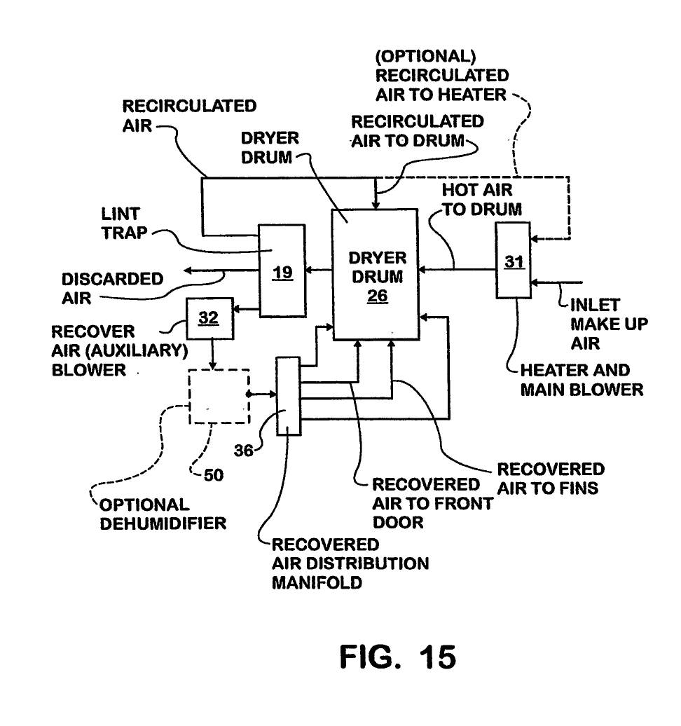

Shown in FIG. 15 is a block schematic diagram of the structures comprising the dryer 10, and showing air flow and recovered air flow therethrough more clearly.

Also, although in a preferred embodiment recirculated air may be reheated by the heater 31 and fed back into the drum 26, it will be understood that this is optional.

Still further, it will be understood that motor(s) and blower(s) of the dryer 10 generate heat and that such added heat will be used in the dryer 10 to help dry the clothes;

Also, the moist air from the clothes being dried in the dryer 10 will be used to help cooling of such motor(s) and blower(s).

Also, it will be understood that a retrofit of conventional dryers is possible through conversion of the conventional dryer (such as that abovementioned Speed Queen) to incorporate a substantial similar airflow path through the dryer, as exemplified herein.

A kit comprising items such as a door and door vent with appurtenant required structures, hoses, a motor and auxiliary blower (if needed) and possibly even a mesh screen drum could be provided. Thus, retrofitting a conventional dryer is within the scope of the invention.

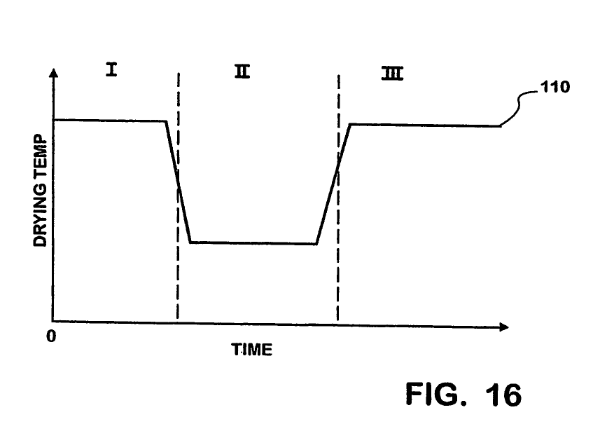

In FIG. 16, the plot of drying temperature versus time is shown in phase I, the simulated “hang drying” time is around 120° F. Then in phase II, the “gentle cycle” with very light mechanical tumbling, the temperature is brought down to about 50° F. Then in the normal drying time the temperature may be brought back up to about 120° F. The dryer drum speeds are high (about 75 RPM) in phase I, low (about 17-18 RPM) in phase II and medium (about 35 RPM) in phase III, with-the dot 110 representing completed drying.

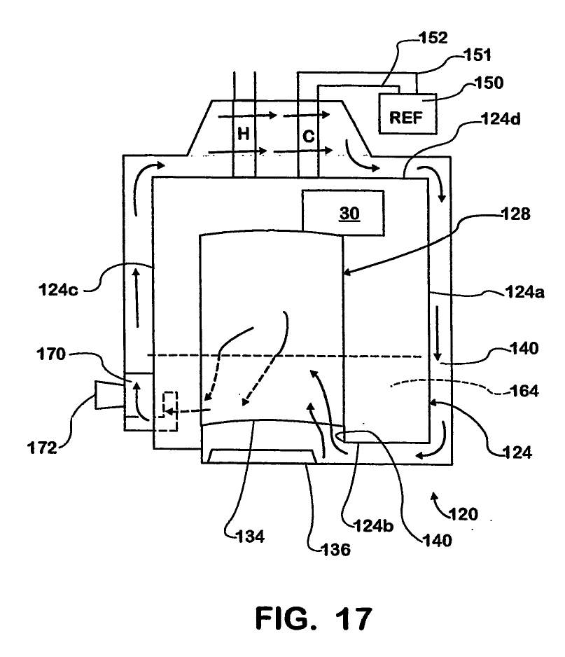

Referring to FIG. 17, the dryer is indicated at 120 and has a cabinet 124 including side walls 124a, 124b, 124c and 124d. Inside the cabinet 124 is the dryer drum 128 which can be rotated at high, medium or slow speeds respectively by a variable speed motor or transmission, indicated at 130. The drum has an open end 134 which in conjunction with the cabinet is closed by a door 136. Adjacent the door 136 is the recirculating dryer air duct exit 140 into the interior of the dryer drum wherein the clothes are placed.

As can be seen, this air flows form a duct 146 having situated therein a cooling coil or heat exchange for providing cool air and dehumidification, indicated at “C”, and a heating coil or exchanger such as using steam to heat the recirculating air, and indicated by H. As shown, the refrigeration or cooling means for providing the cool air or dehumidification is provided at 150 and connected to the heat exchange C by lines 151 and 152.

As can be seen, recirculated air can be supplied to the drum then pulled into the lint trap 164 below by a blower 170 and blower motor 172. Then the blower 170 with motor 172 sends the air through H and/or C or both to be returned via duct 146 to the dryer drum 128.

While several embodiments have been described, it should be understood that the apparatus and method of the present invention include equivalent structures and steps of those described in the accompanying claims.

What is claimed is:

1. A clothes dryer, including a housing, a dryer door, a dryer drum, a heat source, comprising a means for recovering air after it leaves the dryer drum, a means for increasing the velocity of the recovered air, means for distributing the recovered air including duct means for supplying air to the periphery of the drum and means for removing moisture from the recovered air before distributing the recovered air, whereby the dryer will dry clothes quickly.

2. A clothes dryer as in claim 1, wherein said duct means distributes recovered air to the circumference of said dryer drum.

3. A clothes dryer as in claim 2, wherein said duct means also distributes recovered air by said dryer door.

4. A clothes dryer as in claim 3, wherein said duct means distributes recovered air through said dryer door.

5. A clothes dryer as in claim 1, wherein said duct means distributes recovered air by said dryer door.

6. A clothes dryer as in claim 5, wherein said duct means distributes recovered air through said dryer door.

7. A clothes dryer as in claim 1, further comprising a distribution header for distributing recovered air.

8. A clothes dryer as in claim 7, further comprising one or more ducts connected to said distribution header.

9. A clothes dryer as in claim 8, further comprising two or more ducts connected to said distribution header.

10. A clothes dryer as in claim 1, wherein said means for increasing the velocity of the recovered air comprises a driven blower.

11. A clothes dryer as in claim 1, wherein said dryer has a motor, and said driven blower is driven by said motor.

12. A clothes dryer as in claim 1, wherein said dryer has at least two motors, one for driving said drum and the other for driving said blower.

13. A clothes dryer as in claim 1, wherein said means for removing moisture is a heat exchange.

14. A clothes dryer as in claim 13, wherein said heat exchanger has a cold fluid circulated therein to cool the recovered air to remove the moisture therein.

15. A clothes dryer as in claim 14, wherein said heat exchanger is externally supplied with cold fluid.

16. A clothes dryer as in claim 14, wherein said heat exchanger forms part of a cooling unit.

17. A clothes dryer as in claim 16, wherein said cooling unit is a refrigeration means.

18. A clothes dryer as in claim 1, wherein said means for removing moisture is a refrigeration means.

19. A clothes dryer as in claim 1, wherein said means for removing moisture is an air cooling means including at least one of: an air conditioner, refrigerator, circulated cold fluid, cold water and ice water.

20. A clothes dryer as in claim 3, wherein said duct means further comprising a distribution header for distributing recovered air, further comprising two or more ducts connected to said distribution header, said means for increasing the velocity of the recovered air comprises a driven blower, said dryer has at least two motors, one for driving said drum and the other for driving said blower, said means for removing moisture is a heat exchange, said heat exchanger has a cold fluid circulated therein to cool the recovered air to remove the moisture therein.

21. A clothes dryer as in claim 20, wherein said means for removing moisture is an air cooling means including at least one of: an air conditioner, refrigerator, circulated cool fluid, cold water and ice water.

22. A clothes dryer, including a housing, a dryer door, a dryer drum, a heat source, a lint trap, comprising a means for recovering air after the lint trap, a means for increasing the velocity of the recovered air, means for distributing the recovered air including at least two of the following:
a) first duct means for supplying air axially through the dryer door,
b) second duct means for supplying air to the outer periphery of the drum,
c) third duct means for supplying air to the circumference of the dryer, and
d) means for removing moisture from the recovered air before distributing the recovered air,
whereby the dryer will dry clothes quickly.

23. A method for drying clothes using a dryer having a heat source, a dryer drum, a door for the dryer, a means for moving air from the heat source through the dryer drum, comprising the steps of
recovering at least some of the heated air after the dryer drum,
boosting the velocity of the recovered air,
distributing air to the periphery of the dryer drum, and
dehumidifying the recovered air before it is distributed to the dryer drum,
whereby clothes in the dryer can be quickly and efficiently dried.

24. A method as in claim 23, wherein said step of distributing air comprises the steps of delivering the recovered air to at least two different locations in said dryer drum.

25. A method as in claim 24, wherein said step of delivering the recovered air delivers air to three or more locations in said dryer drum.

26. A method as in claim 24, wherein said dryer includes a lint trap and the step of recovering air recovers air after said lint trap.

27. A method as in claim 23, wherein the step of boosting the velocity of the recovered air, includes the step of drawing the recovered air into a blower and blowing the recovered air.

28. A method as in claim 23, wherein the step of dehumidifying the recovered air includes the step of cooling the recovered air to remove moisture therein.

29. A method as in claim 23, wherein the step of removing the recovered air occurs prior to the step of dehumidifying the recovered air.

30. A method as in claim 23, wherein the step of dehumidifying the recovered air includes the step of air conditioning the recovered air.

31. A method as in claim 23, wherein the step of dehumidifying the recovered air includes the step of refrigerating the recovered air.

32. A method as in claim 24, wherein said step of delivering the recovered air delivers air to three or more locations in said dryer drum, said dryer including a lint trap and the step of recovering air recovers air after said lint trap, the step of boosting the velocity of the recovered air, includes the step of drawing the recovered air into a blower and blowing the recovered air.

33. A method as in claim 32, wherein the step of dehumidifying the recovered air includes the step of cooling the recovered air to remove moisture therein, the step of removing the recovered air occurs prior to the step of dehumidifying the recovered air, and the step of dehumidifying the recovered air includes the step of one of air conditioning the recovered air and refrigerating the recovered air.

34. A method for drying clothes using a dryer having a heat source, a dryer drum, a door for the dryer, a lint trap, a means for moving air from the heat source through the dryer drum, and through the lint trap, comprising the steps of:
recovering at least some of the heated air after the lint trap,
boosting the velocity of the recovered air, and
distributing the recovered air to at least two of the following:
distributing air axial into the dryer drum through the dryer door,
distributing air to the center periphery of the dryer drum,
distributing air to the circumference of the dryer drum, and
dehumidifying the recovered air before it is distributed to the dryer drum,
whereby clothes in the dryer can be quickly and efficiently dried.

35. A clothes dryer having a dryer drum and a door for closing the dryer, means provided for circulating drying air, means for selectively turning the dryer drum:
so that clothes therein do not tumble and so that clothes do tumble.

36. A clothes dryer as in claim 35, wherein said means for selectively turning the dryer drum operates at at least two different speeds.

37. A clothes dryer as in claim 35, wherein said means for selectively turning the dryer drum has a slow speed, a medium speed and a high speed.

38. A clothes dryer as in claim 37, said slow speed permits said clothes to gently tumble, said medium speed is for conventional tumbling, and said high speed is to prevent said clothes from tumbling.

39. A clothes dryer as in claim 35, further comprising control means for automatically controlling said means for selectively turning the dryer drum.

40. A clothes dryer as in claim 38, further comprising control means for automatically controlling said means for selectively turning the dryer drum to first said high speed to permit drying without tumbling, then to said slow speed to permit drying with gentle tumbling, and to said medium speed to permit conventional tumbling and drying.

41. A clothes dryer as in claim 35, having means for heating the drying air and means for cooling the drying air.

42. A clothes dryer as in claim 41, said means for heating the drying air being utilized when said means for selectively turning the dryer drum is turning so that the clothes do not tumble.

43. A clothes dryer as in claim 41, wherein said means for cooling the drying air is utilized when the clothes are gently tumbled.

44. A clothes dryer as in claim 43, wherein said dryer drum can be tumbled at a conventional speed and at a slower speed, and said means for cooling air is utilized when said dryer drum turns at said slower speed.

45. A clothes dryer as in claim 44, wherein after said dryer turns a said slow speed it then turns at said conventional speed and said means for heating the drying air is utilized.

46. A clothes dryer as in claim 45, wherein said dryer drum is turned at high speed in one direction then turned at high speed in the opposite direction.

47. A clothes dryer as in claim 46, wherein the reversals of turning are repeated.

48. A clothes dryer as in claim 45, wherein said dryer drum is turned at slow speed in one direction and then turned at slow speed in the opposite direction.

49. A clothes dryer as in claim 48, wherein the reversals of turning are repeated.

50. A clothes dryer as in claim 35, including means for recovering some of the air from the dryer drum and recirculating the recovered air.

51. A clothes dryer as in claim 50, further including a blower for moving the recovered air.

52. A clothes dryer as in claim 50, including means for dehumidifying the recovered air.

53. A clothes dryer as in claim 52, wherein said means for dehumidifying includes a heat exchanger in the path of the recovered air.

54. A clothes dryer as in claim 53, wherein said heat exchanger is supplied with a cold fluid by one of refrigeration, air conditioner, cold water and ice water.

55. A clothes dryer as in claim 37, said slow speed permits said clothes to gently tumble, said medium speed is for conventional tumbling, and said high speed to prevent said clothes from tumbling, control means for automatically controlling said means for selectively turning the dryer drum to first said high speed to permit drying without tumbling, then to said slow speed to permit drying with gentle tumbling, and to said medium speed to permit conventional tumbling, means for heating the drying air and means for cooling the drying air, said means for heating the drying air being utilized when said means for selectively turning the dryer drum is turning so that the clothes do not tumble, means for cooling the drying air is utilized when the clothes are tumbled, and after said dryer turns a said slow speed it then turns at said conventional speed and said means for heating air is utilized.

56. A clothes dryer as in claim 55, wherein said dryer drum is turned at high speed in one direction then turned at high speed in the opposite direction, wherein the reversals in direction are repeated, said drying drum is then turned at slow speed in one direction and then turned at slow speed in the opposite direction and said reversals of turning are repeated, including means for recovering some of the air from the dryer drum and recirculating the recovered air, a blower for moving the recovered air, means for dehumidifying the recovered air, including a heat exchanger in the path of the recovered air, said heat exchanger being supplied with a cold fluid by one of, refrigeration, air conditioner, cold water, ice water.

57. A method of drying clothes without shrinking, comprising first drying the clothes without tumbling, drying the clothes with cold air with gentle tumbling and drying the clothes with warm air.

58. A method as in claim 57, wherein when drying the clothes without tumbling supplying warm air for drying the clothes.

59. A method as in claim 57, wherein when drying the clothes in the dryer drum without tumbling turning the dryer drum in one direction then the other.

60. A method as in claim 59, wherein the reversal of directions are repeated.

61. A method as in claim 59, wherein the drying without tumbling is carried on for about 1 to 4 minutes before reversing direction.

62. A method as in claim 57, wherein after drying without tumbling the clothes are gently tumbled.

63. A method as in claim 57, when gently tumbling supplying cold air to dry the clothes.

64. A method as in claim 63, including the step of supplying the cold air at 50° F. or less.

65. A method as in claim 64, including supplying the cold air at about 40° F.

66. A method as in claim 57, including the steps of moving the clothes at high speed so they do not tumble, then a slow speed so they gently tumble, and then at medium speed where they conventionally tumble.

67. A method as in claim 66, including the step of drying the clothes with warm air when moving at high speed and medium speed and drying the clothes with cold air when moving at slow speed.

68. A method as in claim 67, including the steps of supplying air at about 120° F. or above for providing warm air and supplying air at about 50° F. or less for providing cold air.

69. A method as in claim 58, when drying the clothes without tumbling the clothes are placed in a dryer drum, and turning the dryer drum in one direction then the other, repeating the reversal of directions, the drying without tumbling is carried on for about 15 to 25 minutes, after drying without tumbling the clothes are gently tumbled, when gently tumbling supplying cold air to dry the clothes, supplying the cold air at 50° F. plus or minus 15° F.

70. A method as in claim 69, including supplying the cold air at about 50° F. to 35° F. and supplying warm air at about 100° F. to 135° F.

71. A drying method for drying clothes comprising:
a) drying the clothes with warm air without tumbling,
b) drying the clothes with cold air with gentle tumbling, and
c) drying the clothes with warm air at a higher speed to provide more tumbling than during gentle tumbling.
